(19) United States
(12) Patent Application Publication
(10) Pub. No.: US 2007/0167162 A1
(43) Pub. Date: Jul. 19, 2007

(54) Multi-functional communication terminal device and communication relay device for use in noise environment

(76) Inventors: Young Beom Kim, Daejeon (KR); Taeg Yong Kwon, Daejeon (KR); Eun Joo Shin, Daejeon (KR); Young Kyu Lee, Daejeon (KR)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/509,527

(22) Filed: Aug. 24, 2006

(30) Foreign Application Priority Data
Dec. 30, 2005 (KR) 10-2005-0134816

(51) Int. Cl. H04Q 7/20; H04M 11/04

(52) U.S. Cl. 455/435.1; 455/404.1

(57) ABSTRACT

Disclosed herein is a multi-functional communication terminal device and communication relay device for use in a noise environment. To this end, the present invention provides a multi-functional communication terminal device for use in a noise environment, comprising: a cellular phone which is hand-carried by each individual worker within a company; an authentication means installed in the cellular phone for transmitting a predetermined code to the multi-functional communication relay device according to claim 1 to receive authentication for a registration of information about the cellular phone from the multi-functional communication relay device; and a communication terminal device mounted on the worker's ear, wherein the communication terminal device includes: a short-range communication means for enabling shot-range communication with the cellular phone; a speech recognition means for recognizing a speech of the worker and converting the recognized speech into character data; and a microphone for receiving a speech of the worker and a speaker for outputting a speech of a counterpart worker or music to the worker.

### BACKGROUND OF THE INVENTION

1. Field of the Invention

The present invention relates to a communication device, and more particularly to a multi-functional communication terminal device and communication relay device for use in a noise environment.

2. Background of the Related Art

Currently, the use of a portable cellular phone is becoming increasingly common for each individual or worker. Particularly, even workers (staffs, laborers, employees, etc.) within enterprises or factories always hand-carry their portable cellular phones.

However, workers use a separate communication network for the purpose of various interconnections or mutual communications therebetween within a company. That is, they often use interphones or an independent short-wave transceiver. This is because such a wired or wireless communication device is free of a service charge and enable free conversation between limited people.

In addition, lately it is frequently reported that workers suffers from hearing impairment regarded as an industrial accident due to noises generated from factories or manufacturing facilities. Such on-site noises leads to the increasing unwillingness of Korean workers to take on so-called 3D (difficult, dirty and dangerous) jobs, thus bringing about the problem of unbalanced manpower supply and demand

However, in case where it is desired to use a separate radio transceiver, a cellular phone or an interphone in such a noise environment, it is required that a worker should take off his safety helmet or ear protective gear. Therefore, the worker could not avoid the interference of noise with the conversation with another, thereby causing him to speak loudly or unavoidably accept hearing damage.

### SUMMARY OF THE INVENTION

Accordingly, the present invention has been made to address and solve the above-mentioned problems occurring in the prior art, and it is a first object of the present invention to provide a multi-functional communication terminal device and communication relay device for use in a noise environment, which enables free conversation between workers while minimizing their hearing impairment even in such a noise environment.

A second object of the present invention is to provide a multi-functional communication terminal device and communication relay device for use in a noise environment, which includes an MP3 playing section such as an MP3 player to allow a worker to appreciate music, and is configured in the form of a head set or a safety helmet to be worn on his head.

A third object of the present invention is to provide a multi-functional communication terminal device and communication relay device for use in a noise environment, in which in case where there occurs an emergency situation such as fire, explosion, earthquake, earth leakage, power failure, inundation, collapse, ground subsidence, etc., within a factory or a company, all the workers can be rapidly informed of it, and if an emergency situation occurs to an individual worker, surrounding workers or a central controller can be informed of it so as to provide a help to him.

To accomplish the above object, according to one aspect of the present invention, there is provided a multi-functional communication relay device for use in a noise environment, including:

a wireless communication means for enabling speech and data communication with an external wireless communication network through a base station;

a registering means for wirelessly registering information about a cellular phone of each individual worker who is positioned within a company as a predetermined code; and

a cellular phone communicating means for enabling communication with the cellular phone and communication between the cellular phones based on the predetermined code registered by the registering means.

Preferably, the multi-functional communication relay device may further comprise a transmission means for transmitting an emergency alarm signal or a broadcasting signal to a cellular phone of each individual worker who is positioned within a company.

To accomplish the above object, according to another aspect of the present invention, there is also provided a multi-functional communication terminal device for use in a noise environment, comprising:

a cellular phone which is hand-carried by each individual worker within a company;

an authentication means installed in the cellular phone for transmitting a predetermined code to the multi-functional communication relay device according to claim 1 to receive authentication for a registration of information about the cellular phone from the multi-functional communication relay device; and

a communication terminal device mounted on the worker's ear,

wherein the communication terminal device includes:

a short-range communication means for enabling shot-range communication with the cellular phone;

a speech recognition means for recognizing a speech of the worker and converting the recognized speech into character data; and

a microphone for receiving a speech of the worker and a speaker for outputting a speech of a counterpart worker or music to the worker.

Preferably, the communication terminal device may further include an MP3 playing section for receiving a music file through a wireless or wired mode or a USB terminal and playing the received music file.

In addition, preferably, the communication terminal device may be configured in the form of a safety helmet or a head set.

Most preferably, the communication terminal device may further include:

a key input section; and

an emergency alarming section for transmitting an emergency alarm signal in response to an input signal generated from the key input section

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic diagrammatic view illustrating the construction of a multi-functional communication terminal device and communication relay device for use in a noise environment according to the present invention; and

FIG. 2 is a block diagram illustrating the inner construction of a multi-functional communication terminal device 62 and an outer appearance of a cellular phone 73 which is hand-carried by each individual worker.

### DETAILED DESCRIPTION OF THE PREFERRED EMBODIMENT

Reference will now be made in detail to the preferred embodiment of the present invention with reference to the attached drawings.

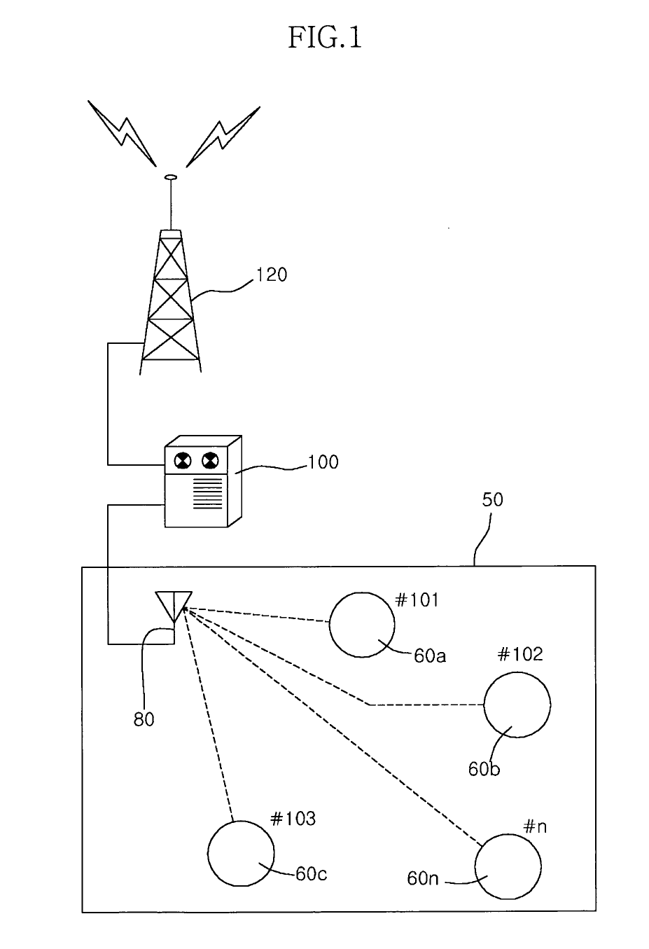

FIG. 1 is a schematic diagrammatic view illustrating the construction of a multi-functional terminal device for communication in a noise environment and a communication relay device thereof according to the present invention.

As shown in FIG. 1, the construction of the present invention can be divided into a multi-functional communication relay device 100 and a communication terminal device which is arried by each worker 60

The multi-functional communication relay device 100 is connected with an external base station 120 to enable wireless communication between workers. A representative example of such wireless communication includes code division multiple access (CDMA) communication. Such a multi-functional communication relay device 100 may be directly connected with a server of a communication service company. Also, contents for communication include voices as well as a variety of data such as video data, music data, game, etc.

In addition, the multi-functional communication relay device 100 includes a registering means for wirelessly registering information about a cellular phone 73 of each individual worker 60 who is positioned within a company 60 as a predetermined code. The predetermined code is composed of a cellular phone number, a cellular phone's serial number (for example, #101, #102, #n) and a cellular phone password. The registration of the cellular phone information can be carried out such that a worker makes a phone call to a specific telecommunication number (for example, 010-000-0000) retained by the multi-functional communication relay device 100 through a corresponding cellular phone 73 so as to confirms his identity and to be assigned with a code.

Moreover, the multi-functional communication relay device 100 enables communication with the cellular phone 73 based on the predetermined code registered by the registering means. That is, communication between the multi-functional communication relay device 100 and the cellular phone 73, and communication between the cellular phones 73 is enabled. Only a worker who is authenticated through the predetermined code can perform the communication therebetween so that the communication is not available to an outsider who is not authenticated. To this end, it is required that a header of an electric wave transmitted from the multi-functional communication relay device 100 should include a code data and the cellular phone 73 should have a function of sensing the content of the header. That is, the cellular phone 73 downloads a program for recognizing the header upon the registration of the code from the multi-functional communication relay device 100 and has the downloaded program installed therein.

The multi-functional communication relay device 100 further includes a transmission means for transmitting an emergency alarm signal or a broadcasting signal (unidirectional RF signal) to a cellular phone 73 of each individual worker 60 who is positioned within a company 50. Thus, when an emergency situation occurs, all the workers 60 within the company 50 can be informed of it and can be provided with an intra-company broadcasting service or an announcement

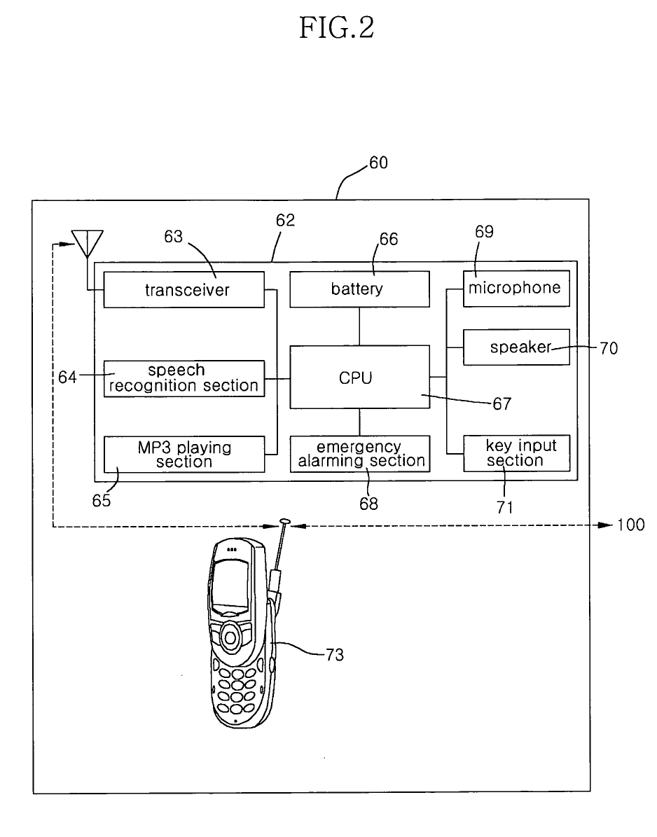

FIG. 2 is a block diagram illustrating the inner construction of a communication terminal device 62 and an outer appearance of a cellular phone 73 which is hand-carried by each individual worker.

As shown in FIG. 2, an individual worker 60 hand-carries his cellular phone 73 and the communication terminal device 62.

The cellular phone 73 is a typical cellular phone which each individual worker 60 within a company 50 hand-carries. In this case, a specific program is downloaded from the multi-functional communication relay device 100 and installed in the cellular phone 73. Such specific program is intended to grasp the header content of an electric wave being transmitted so as to identify whether or not a signal is transmitted to the cellular phone 73 from the multi-functional communication relay device 100.

In addition, the cellular phone 73 includes an authentication means for transmitting a predetermined code to the multi-functional communication relay device 100 to receive authentication for a registration of information about the cellular phone 73 from the multi-functional communication relay device 100.

The communication terminal device 62 is configured in the form of a safety helmet or a head set and includes a transceiver 63, a speech recognition section 64, an MP3 playing section 65, a battery 66, a central processing unit (CPU) 67, an emergency-alarming section 68, a microphone 69, a speaker 70 and a key input section 71.

The transceiver 63 is adapted to communicate with the cellular phone 73, and includes wireless communication means for short-range communication (for example, bluethooth, etc.), a wired connection means or a modem, etc.

The speech recognition means 64 serves to recognize a speech of a worker 60 when he calls another worker's name or a previously registered name (for example, eating house, security guard, main gate, warehouse, etc) and convert the recognized speech into character data. Thereafter, a phone number corresponding to the converted character data is retrieved from a phone directory of the cellular phone 73.

The MP3 playing section 65 is adapted to receive a music file through a wireless or wired mode or a USB terminal and play the received music file. The format of the music file is typically configured in the form of MP3, but may be other file format such as WMA format.

The battery 66 serves as a secondary battery for supplying electric power to the communication terminal device 62 and may be used as a regular power source of the cellular phone 73 if the battery 66 is wiredly connected with the cellular phone 73.

The CPU 67 is a central processor and a typical example thereof includes a microcomputer (MICOM)

The emergency alarming section 68 is adapted such that if an emergency situation occurs to an associated worker 60, surrounding workers or a central controller can be informed of it. The emergency alarming section 68 is operated when a button is pressed through the key input section 71 included in the communication terminal device 62 together therewith. Thus, the emergency alarming section 68 stores basic information (for example, name, work place, position, blood type, phone number, etc) regarding an associated individual worker 60 therein for the purpose of transmission of the information at the time emergency situations.

The microphone 69 functions to receive a speech of a worker 60, and the speaker 70 functions to output a speech of a counterpart worker or music to the worker 60. Particularly, the speaker 70 also serves to interrupt noises generated from a factory as being in close contact with his ear. In case of using a safety helmet or a head set, a sensible nose level is less than 55 Db.

The key input section 71 includes a power button, an emergency button for operating the emergency alarming section 568, a MP3 play button for operating the MP3 playing section 65, etc.

An operation method of a multi-functional communication terminal device and communication relay device for use in a noise environment as constructed above will be described hereinafter with reference to the accompanying drawings.

First, a worker 60 makes a phone call to a specific phone (for example, its phone number is 010-000-0000) operated by the multi-functional communication relay device 100 using his cellular phone 73, and then registers his name, phone number, password, etc., so as to be assigned with a serial number. Then, the worker 60 downloads a program for identifying the content of a header of an electric wave to his cellular phone 73 from the multi-functional communication relay device 100 so as to install the downloaded program in his cellular phone 73.

Thereafter, the worker 60 goes to a factory to work while hand-carrying his cellular phone 73 and then converting an incoming mode of the cellular phone. Then, wireless communication between workers can be performed through the multi-functional communication relay device 100.

In case where an intra-company broadcasting service is provided to the workers in the morning, the multi-functional communication relay device 100 transmits a broadcasting signal (unidirectional RF signal) to cellular phones 73 of all the workers 60 within a company 50. Then, each cellular phone 73 receives the broadcasting signal from the multi-functional communication relay device 100 for transmission to the communication terminal device 62 to output the broadcasting contents corresponding to the broadcasting signal to the outside through the speaker 70 of the communication terminal device 62.

In the meantime, in case where the intra-company broadcasting service is provided in the form of audio broadcasting, the above process is similarly performed. Alternatively, in case where the intra-company broadcasting service is provided in the form of video broadcasting, moving pictures being played are displayed in the cellular phone 73 along with the above process.

If it is desired for the worker 60 to call another worker, he calls the counterpart worker by name. The speech recognition section 64 recognizes his speech when calling by name and converts the recognized speech into character data such as for example “Gil-Dong Hong”. Then, the CPU 67 allow information about “Gil-Dong Hong” to be retrieved from a phone directory stored in the cellular phone 73 to extract a corresponding serial number or a phone number of “Gil-Dong Hong”. The extracted data is transmitted to the multi-functional communication relay device 100 for connection with an associated worker. Such a phone directory database is included in each cellular phone 73, but may be included in the multi-functional communication relay device 100 to enable integral operation.

In case where an emergency situation occurs to a worker 60 during the work, he depresses an emergency button of the key input section 71, Then, the emergency alarming section 68 senses the depression of the emergency button and generates a alarm signal in response to the depression to transmit the alarm signal to the multi-functional communication relay device 100. The data being transmitted from the emergency alarming section 68 to the multi-functional communication relay device 100 includes the worker's name, work place, position, blood type, phone number, etc. Thus, a central control center can rapidly cope with this emergency situation.

In addition, in case where there occurs an emergency situation such as, for example, fire, explosion, earthquake, earth leakage, power failure, inundation, collapse, ground subsidence, etc., within a factory, the multi-functional communication relay device 100 informs all the registered workers of it. Accordingly, a rapid instruction can be given to the workers even in a noise environment.

As described above, according to the present invention, free conversation between workers is enabled while minimizing their hearing impairment even in a noise environment, leading to an elimination of the need for the worker to take off his safety helmet. As used herein, “noise” environments includes “noisy” environments and references any environment where noise could cause communication difficulties.

In addition, the present invention is provided with an MP3 playing section such as an MP3 player to allow a worker to appreciate music, and is configured in the form of a head set or a safety helmet to be worn on his head, thereby increasing safety and removing an inconvenience of activities.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A multi-functional communication relay device for use in a noise environment, comprising:
a wireless communication means for enabling speech and data communication with an external wireless communication network through a base station;
a registering means for wirelessly registering information about a cellular phone of each individual worker who is positioned within a company as a predetermined code; and
a cellular phone communicating means for enabling communication with the cellular phone and communication between the cellular phones based on the predetermined code registered by the registering means.

2. The multi-functional communication relay device as defined in claim 1, further comprising a transmission means for transmitting an emergency alarm signal or a broadcasting signal to a cellular phone of each individual worker who is positioned within a company.

3. A multi-functional communication terminal device for use in a noise environment, comprising:
a cellular phone which is hand-carried by each individual worker within a company;
an authentication means installed in the cellular phone for transmitting a predetermined code to the multi-functional communication relay device according to claim 1 to receive authentication for a registration of information about the cellular phone from the multi-functional communication relay device; and
a communication terminal device mounted on the worker's ear,
wherein the communication terminal device includes:
a short-range communication means for enabling shot-range communication with the cellular phone;
a speech recognition means for recognizing a speech of the worker and converting the recognized speech into character data; and
a microphone for receiving a speech of the worker and a speaker for outputting a speech of a counterpart worker or music to the worker.

4. The multi-functional communication terminal device as defined in claim 3, wherein the communication terminal device further includes an MP3 playing section for receiving a music file through a wireless or wired mode or a USB terminal and playing the received music file.

5. The multi-functional communication terminal device as defined in claim 3, wherein the communication terminal device is configured in the form of a safety helmet or a head set.

6. The multi-functional communication terminal device set forth in claim 3, wherein the communication terminal device further includes:
a key input section; and
an emergency alarming section for transmitting an emergency alarm signal in response to an input signal generated from the key input section.

7. A multi-functional communication relay device for use in a noisy environment, comprising:
a wireless communication device for enabling speech and data communication with an external wireless communication network through a base station;
a registering device for wirelessly registering information about a cellular phone of each individual worker who is positioned within a company as a predetermined code; and
a cellular phone communicating device for enabling communication with the cellular phone and communication between the cellular phones based on the predetermined code registered by the registering device.

8. The multi-functional communication relay device as defined in claim 7, further comprising a transmission device for transmitting an emergency alarm signal or a broadcasting signal to a cellular phone of each individual worker who is positioned within a company.

9. A multi-functional communication terminal device for use in a noisy environment, comprising:
a cellular phone which is hand-carried by each individual worker within a company;
an authentication device installed in the cellular phone for transmitting a predetermined code to a multi-functional communication relay device to receive authentication for a registration of information about the cellular phone from the multi-functional communication relay device; and
a communication terminal device mounted on the worker's ear,
wherein the communication terminal device includes:
a short-range communication device for enabling shot-range communication with the cellular phone;
a speech recognition device for recognizing a speech of the worker and converting the recognized speech into character data; and
a microphone for receiving a speech of the worker and a speaker for outputting a speech of a counterpart worker or music to the worker.

10. The multi-functional communication terminal device as defined in claim 9, wherein the communication terminal device further includes an MP3 playing section for receiving a music file through a wireless or wired mode or a USB terminal and playing the received music file.

11. The multi-functional communication terminal device as defined in claim 9, wherein the communication terminal device is configured in the form of a safety helmet or a head set.

12. The multi-functional communication terminal device set forth in claim 9, wherein the communication terminal device further includes:
a key input section; and
an emergency alarming section for transmitting an emergency alarm signal in response to an input signal generated from the key input section.
